(19) United States
(12) Patent Application Publication
(10) Pub. No.: US 2023/0169339 A1
(43) Pub. Date: Jun. 1, 2023

(54) TIME SERIES PREDICTION AND CLASSIFICATION USING SILICON PHOTONIC RECURRENT NEURAL NETWORK

(71) Applicant: NEC Laboratories America, Inc., Princeton, NJ (US)

(72) Inventors: Thomas FERREIRA de LIMA, Princeton, NJ (US); Hsuan-Tung PENG, Princeton, NJ (US)

(73) Assignee: NEC LABORATORIES AMERICA, INC, Princeton, NJ (US)

(21) Appl. No.: 18/072,626

(22) Filed: Nov. 30, 2022

Related U.S. Application Data
(60) Provisional application No. 63/284,775, filed on Dec. 1, 2021.

(51) Int. Cl. G06N 3/08; G06N 3/044

(52) U.S. Cl. CPC G06N 3/08; G06N 3/044

(57) ABSTRACT

A photonics-assisted platform for time series prediction and classification that performs signal processing directly after the signal acquisition before any analog-to-digital conversion by using a hardware neural network with recurrent connections, implemented in a silicon photonic chip. This neural network recurrency can be implemented in silicon photonics with a much lower latency than state-of-the-art electronic systems. The recurrent neural network can detect temporal correlations and extract features from the time series signal, and therefore reduce the latency constraints for the analog-to-digital conversion and further digital signal processing.

### CROSS REFERENCE

This application claims the benefit of U.S. Provisional Patent Application Ser. No. 63/284,775 filed 1 Dec. 2021 the entire contents of which being incorporated by reference as if set forth at length herein.

### TECHNICAL FIELD

This disclosure relates generally to the processing of time series data. More particularly, it discloses systems and methods for time series prediction and classification using silicon photonic recurrent neural networks.

### BACKGROUND

Many important cyber-physical systems (CPS)—a computer system in which a mechanism is controlled or monitored by computer-based algorithms—including, for example, industrial machines, telecommunication equipment, autonomous vehicles, smart electric grids, and scientific instruments, require or generate a representation of physical phenomena as time series data. For certain applications, the volume of such time series data is too large to process in real time because of limitations of digital processing hardware. One approach to such circumstance is to record and store short bursts of time series data for subsequent, post-event diagnostics. Unfortunately, this approach is not workable for real time systems, which necessarily process data and events that have critically defined time constraints.

### SUMMARY

An advance in the art is made according to aspects of the present disclosure directed to system and methods that process high-volume time series data in real time in a cyber domain such that a control or other decision may be made within a deterministic latency in a physical domain.

In sharp contrast to the prior art, systems, and methods according to aspects of the present disclosure perform signal processing directly after signal acquisition—before any analog-to-digital conversion—through the use of a hardware neural network having recurrent connections, implemented in a silicon photonic structure/chip. Advantageously, and as will be readily appreciated by those skilled in the art, the neural network recurrency is implemented in silicon photonics exhibiting a lower latency than state-of-the-art electronic embodiments known in the art. The recurrent neural network according to aspects of the present disclosure detects temporal correlations and extracts features from time series signals, and therefore reduces latency constraints for analog-to-digital conversion and any subsequent digital signal processing.

### BRIEF DESCRIPTION OF THE DRAWING

A more complete understanding of the present disclosure may be realized by reference to the accompanying drawing in which:

FIG. 1 is a schematic diagram showing an illustrative cyber-physical system according to aspects of the present disclosure;

FIG. 2 is a schematic diagram showing an illustrative operational cyber-physical system highlighting time latencies that occur between anomalous event and detection according to aspects of the present disclosure;

FIG. 3(A) is a schematic diagram showing an illustrative analog preprocessing system and experimental setup of Si photonic recurrent neural network (SiPRNN) according to aspects of the present disclosure;

FIG. 3(B) is a schematic diagram showing an illustrative single neuron of the photonic neural network of FIG. 1(A) according to aspects of the present disclosure;

FIG. 3(C) is a schematic diagram showing an illustrative mathematical model of a photonic recurrent neural network according to aspects of the present disclosure;

FIG. 4(A) and FIG. 4(B) are schematic diagrams showing an illustrative time delayed single recurrent neural network according to aspects of the present disclosure; and

FIG. 4(c) is a schematic diagram showing an illustrative neural network architecture for time series classification according to aspects of the present disclosure.

### DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGS. comprising the drawing are not drawn to scale.

By way of some additional background, we note that many important cyber-physical systems, e.g. industrial machines, telecommunication equipment, autonomous vehicles, smart electric grids, scientific instruments, etc., generate and/or collect and/or utilize and/or analyze time-series data representing physical phenomena. Unfortunately—for certain applications—the volume of time series data that must be generated, collected, utilized, and/or analyzed is too large to process in real time.

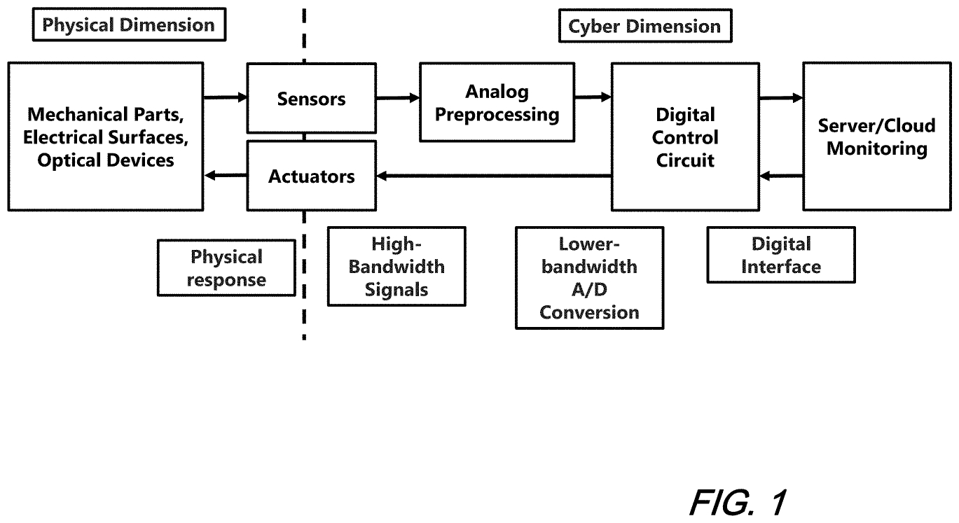

FIG. 1 is a schematic diagram showing an illustrative cyber-physical system according to aspects of the present disclosure. As illustratively shown in that figure, an illustrative cyber-physical system includes both a physical dimension and a cyber dimension. The physical dimension generally includes mechanical parts, electrical surfaces, optical devices, sensors and actuators while the cyber dimension incudes—in addition to sensors and actuators—analog preprocessing, digital control circuits—including control software—and server/cloud monitoring facilities. Shown further are illustrative operations and interconnects including physical responses in the physical dimension and high bandwith, low(er) bandwidth, and digital interface interconnect mechanisms and signals used to effect communication between the various functions.

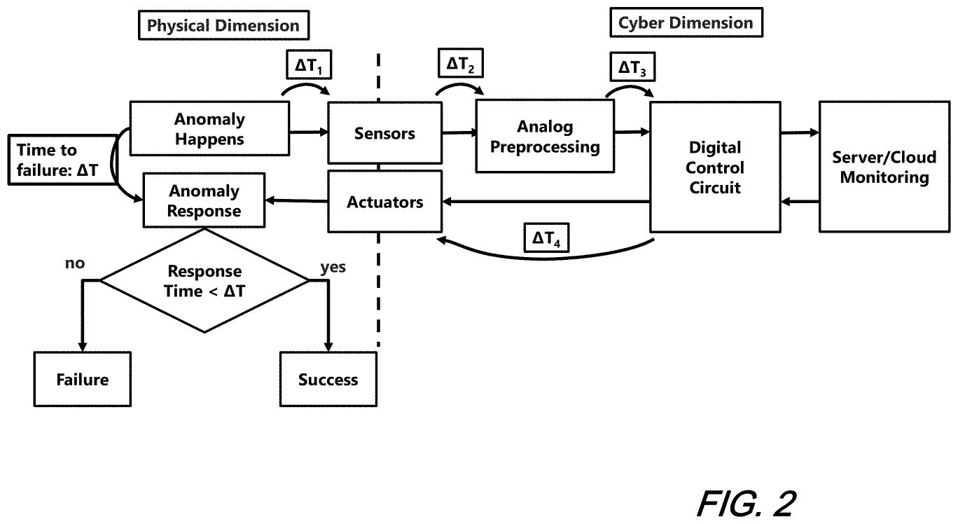

FIG. 2 is a schematic diagram showing an illustrative operational cyber-physical system highlighting time latencies that occur between anomalous event and detection according to aspects of the present disclosure. As may be observed from this illustrative figure, individual operations and communications will introduce accumulating time delays between the occurrence of an anomalous event and a system response precipitated by that event. As usually determined, when a response is within an acceptable time period between occurrence and response, then such operation may be considered successful. When a response is not within an acceptable time period, it is considered a failure.

Systems and methods according to aspects of the present disclosure perform signal processing directly after the signal acquisition—before any analog-to-digital conversion—by using a hardware neural network with recurrent connections, implemented in a silicon photonic chip. This neural network recurrency is implemented in silicon photonics exhibiting a much lower latency than state-of-the art electronic systems. The recurrent neural network can detect temporal correlations and extract features from the time series signal, and therefore reduce the latency constraints for the analog-to-digital conversion and further digital signal processing.

According to aspects of the present disclosure, the photonic neural network, implemented using silicon photonics, is programmed to process high-bandwidth (GHz) input signals in the analog domain. This processing procedure involves transforming signals with a temporal correlation of the input with its recent past, followed by a nonlinear transformation. Because of the combination of temporal correlation and nonlinear transformation, it is well suited to time series that have an underlying nonlinear dynamic model.

While the benefits of recurrent neural networks for processing time series data, and analog recurrent neural networks have been demonstrated in electronics, systems and methods according to aspects of the present disclosure integrate the recurrent neural network onto a silicon photonic chip, which advantageously can handle high-bandwidth signals, otherwise prohibitive to digital systems.

For example, as we shall describe further, such a silicon photonic recurrent neural network according to the present disclosure increases successful prediction of future steps when applied to a benchmark test called NARMA10—an emulation of a nonlinear autoregressive moving average model. In another application, our silicon photonic recurrent neural network according to aspects of the present disclosure successfully analyzes a motor vehicle's engine vibration signals and classifies whether a certain symptom exists or not.

As will be understood and appreciated by those skilled in the art, for a number of these motor vehicle symptoms, it is important to shut a motor vehicle engine down immediately after detection, with minimal latency, to prevent further damage to the motor vehicle. Advantageously, our inventive systems and methods can be generalized to other applications where a hard deadline between problem detection and reaction is necessary It can also be generalized to other systems, including controlling telecommunication equipment, where failing to switch from a soon-to-be blocked communication channel in time would mean loss of connectivity, or self-driving vehicles, where a failure to adjust course in a short time after an anomalous event is detected would potentially include human injury.

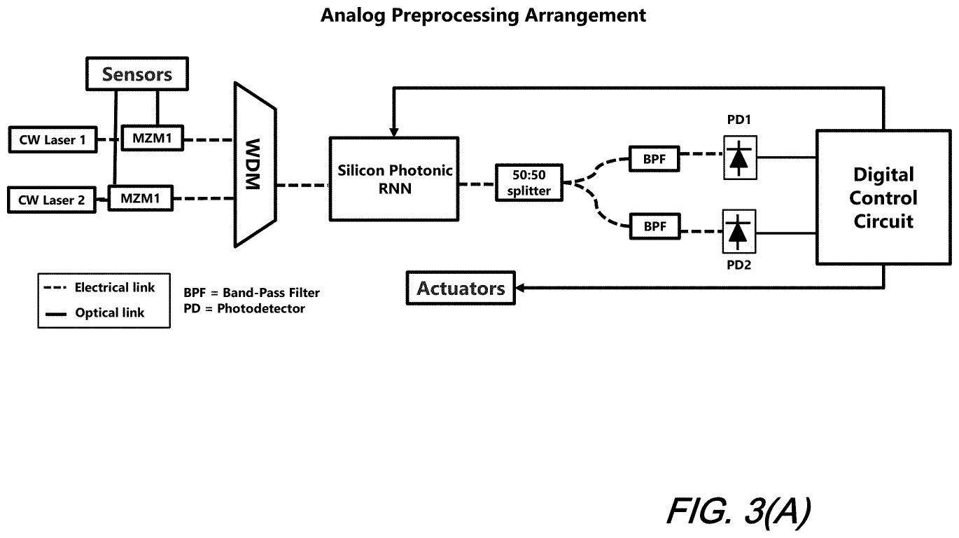

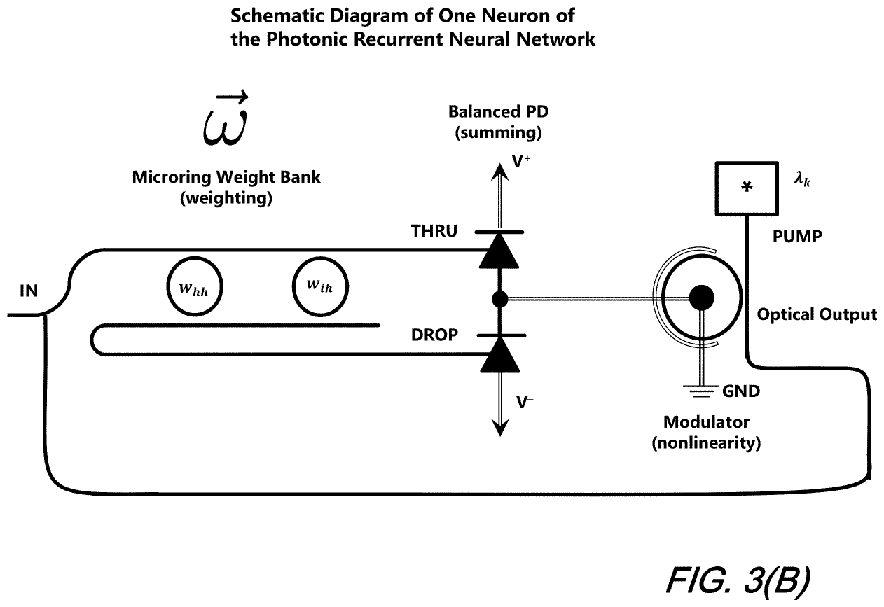

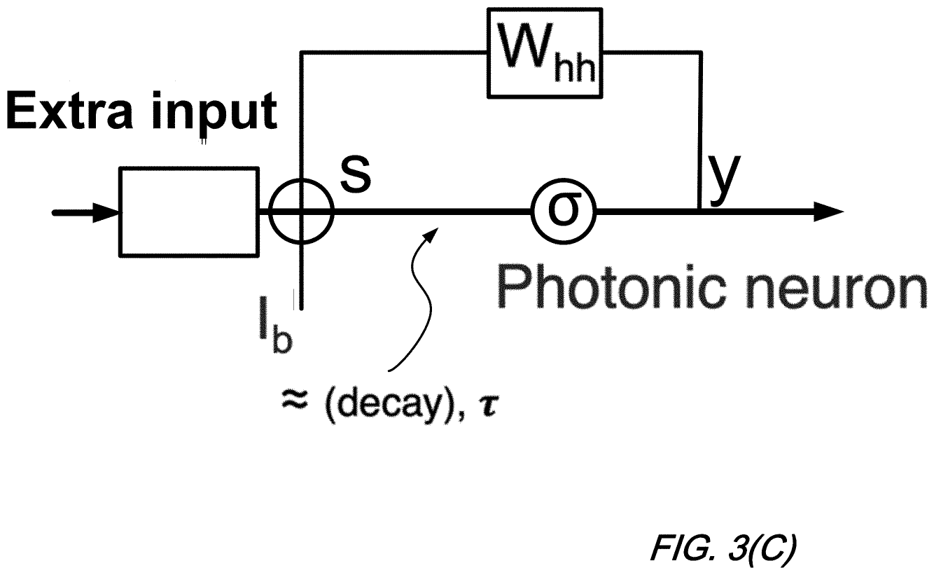

FIG. 3(A) is a schematic diagram showing an illustrative analog preprocessing system and experimental setup of Si photonic recurrent neural network (SiPRNN) according to aspects of the present disclosure.

FIG. 3(B) is a schematic diagram showing an illustrative single neuron of the photonic neural network of FIG. 1(A) according to aspects of the present disclosure.

FIG. 3(C) is a schematic diagram showing an illustrative mathematical model of a photonic recurrent neural network according to aspects of the present disclosure.

With simultaneous reference to these figures, it may be observed that a photonic recurrent neural network is designed as shown in FIG. 3(B), which includes a micro-ring weight bank (MWB), a balanced photodetector (BPD), and a micro-ring modulator neuron of which an output is connected back to an input of the MWB. This neural network is fabricated on a silicon photonic integrated circuit with high-speed optical I/O ports connected to optical fibers and low-speed electrical ports connected to electrical sources for the control of on-chip optical components.

For our purposes herein, the structure of FIG. 3(B) is integrated into an analog preprocessing arrangement such as that shown in FIG. 3(A) wherein analog input signals from sensors are optically modulated and directed to high-speed optical I/O ports. The result of the nonlinear computation is also sent via optical I/O ports to photodetectors and then the digital control circuit for further processing. This two-step process achieves a reduced latency because of the reduced bandwidth required from the Analog preprocessor to the Digital control circuit, compared to a direct alternative from Sensor to Digital Control Circuit.

Device and Experimental Setup

The arrangement shown illustratively in FIGS. 3(A), 3(B), and 3(C) are employed in our experimental evaluation. In this experiment, we focus on one modulator neuron attached to two micro-ring resonators configuring the input coupling weight wᵢₕ and feedback weight wₕₕ respectively.

Results

Advantageously, our inventive SiPRNN can be employed according to one of two approaches namely, a single node time delayed reservoir approach and a dynamical RNN model. The results of each are described as follows.

Time Delayed Reservoir—NARMA-10

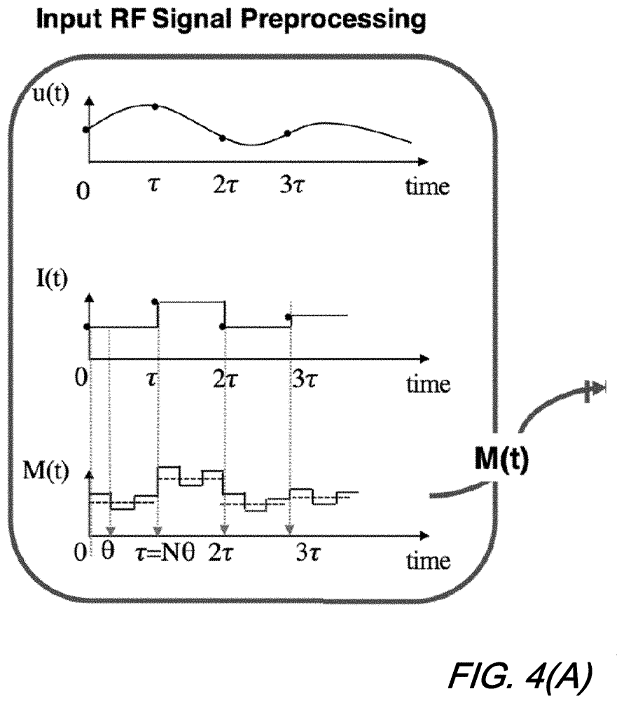

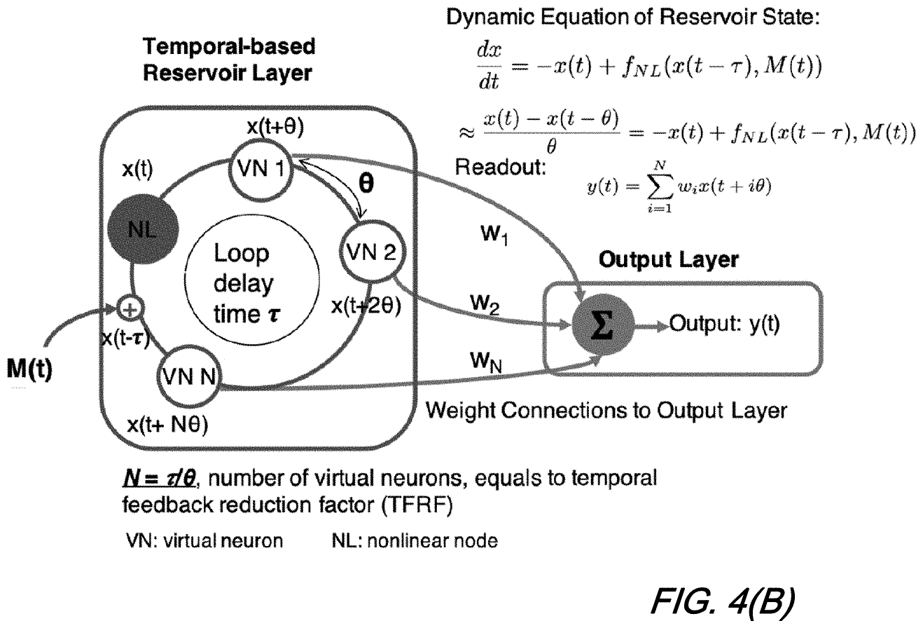

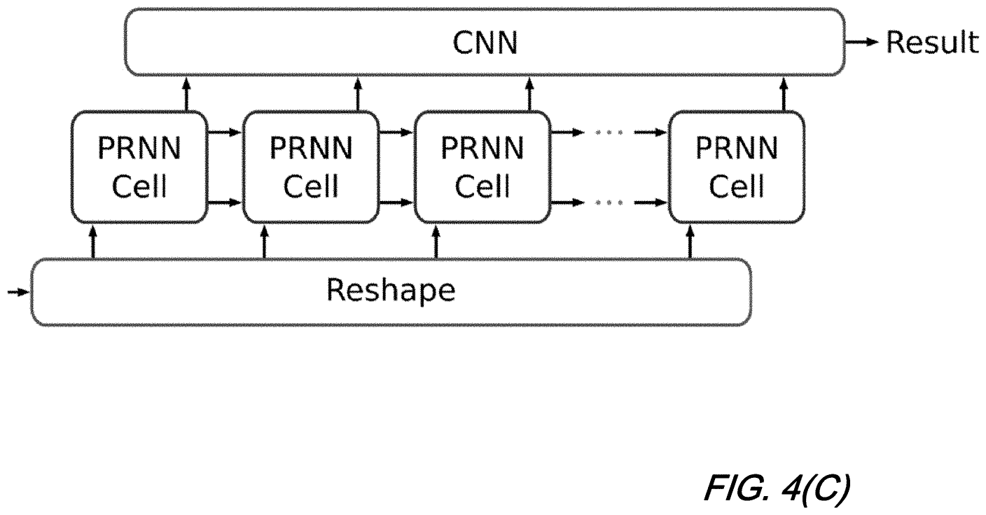

The on-chip single recurrent neuron is considered a single node time delayed reservoir system as illustratively shown in FIG. 4(A) and FIG. 4(B), which is a schematic diagram showing an illustrative time delayed single recurrent neural network according to aspects of the present disclosure.

We perform NARMA-10 prediction using an input weight mask of 100 random values, which are multiplied to each input value of the NARMA-10 series. Experimentally, the weighted input was programmed by arbitrary waveform generator and modulated to optical domain using a Mach-Zehnder modulator, MZM (MZM1 in FIG. 3 (A)). A CW laser exhibiting an output wavelength near the resonance of the on-chip modulator was multiplexed with the input signal and directed to our SiPhotonic chip. The feedback weight value was configured to to be 1, thereby providing nonlinear feedback dynamics, and measured the output of the silicon recurrent neuron. The output time series was then learned to match the NARMA-10 output sequence by ridge regression offline. The prediction using our silicon recurrent neuron was improved from normalized root mean square error (NRMSE)=0.18 to NRMSE=0.1491.

Dynamical Model—Ford a Classification

On the other hand, we experimentally verified the dynamical model of photonic recurrent neuron as shown in the figures.

FIG. 4(C) is a schematic diagram showing an illustrative neural network architecture for time series classification according to aspects of the present disclosure.

The information processing in this network can be described by the following equation set:

$$\frac{d \vec{s}}{dt} = \frac{- \vec{s}}{τ} + {W}_{hh} \vec{y} ( t ) + {W}_{ih} \vec{x} ( t ) , \vec{y} ( t ) = σ ( \vec{s} ( t ) )$$

Where \vec{s} is the neuron's state which is the current injected to modulator neuron, \vec{y} is output optical signal, τ is the time constant of the photonic circuit, Wₕₕ is the feedback weight, Wᵢₕ is the input coupling weight, and σ(.) is the transfer function of the silicon photonic modulator neurons.

It is worth noting that the nonlinear transfer function can be expressed as Lorentzian function,

σ(x)=x²/(x²+(ax+b)²)

where a, b are constants. We used this dynamical model and a CNN with framework to perform Ford A time series classification. The training and validation results showed that the combination of photonic recurrent neural network and CNN model successfully classifies a Ford A test dataset with 92.2%.

### CONCLUSION

At this point we have presented this disclosure using some specific examples and have experimentally demonstrated NARMA-10 time series prediction as a using our SiPhotonic chip as time delayed reservoir system. We also verified the dynamical model and showed its capability to perform time series classification. These results have demonstrated the utility of using photonic recurrent neuron for intelligent time series processing, which enables a wide range of real-world applications such as RF fingerprinting, modulation classification, etc. Those skilled in the art will recognize that our teachings are not so limited, however. Accordingly, this disclosure should only be limited by the scope of the claims attached hereto.

1. An arrangement for time series prediction and classification using silicon photonic recurrent neural network comprising:
input circuitry configured to receive analog sensor signals;
optical conversion circuitry configured to convert the analog sensor signals into analog optical sensor signals
the silicon photonic recurrent neural network configured to receive as input the analog optical sensor signals and transform the analog optical sensor signals with a temporal correlation of the input with its recent past, followed by a nonlinear transformation and output the transformed analog optical sensor signals;
digital conversion circuitry configured to receive and digitize the transformed analog optical sensor signals and output the digitized transformed analog optical sensor signals to digital control circuitry;
the digital control circuitry configured to receive as input the digitized transformed analog optical sensor signals and output actuator control signals in response to the digitized transformed analog optical sensor signals input.

2. The arrangement of claim 1 wherein the silicon photonic recurrent neural network includes a micro-ring weight bank (MWB), a balanced photodetector (BPD) and a micro-ring modulator neuron of which an output is optically connected to an input of the MWB.

3. The arrangement of method of claim 2 wherein the silicon photonic recurrent neural network is a single node time delayed reservoir.

4. The arrangement of claim 2 wherein the silicon photonic recurrent neural network comprises a plurality of photonic recurrent neural network neurons defined by the following relationship:
$$\frac{d \vec{s}}{dt} = \frac{- \vec{s}}{τ} + {W}_{hh} \vec{y} ( t ) + {W}_{ih} \vec{x} ( t ) , \vec{y} ( t ) = σ ( \vec{s} ( t ) )$$
where \vec{s} is the neuron's state which is the current injected to a modulator neuron, \vec{y} is an output optical signal, τ is a time constant of a photonic circuit forming the neuron, Wₕₕ is a feedback weight, Wᵢₕ is an input coupling weight, and σ(.) is a transfer function of silicon photonic modulator neurons.

5. The arrangement of claim 4 wherein the nonlinear transfer function is a Lorentzian function
σ(x)=x²/(x²+(ax+b)²)
where a, b are constants.
